(19) United States
(12) Patent Application Publication
(10) Pub. No.: US 2025/0329081 A1
(43) Pub. Date: Oct. 23, 2025

(54) GENERATING VISUALLY AWARE DESIGN LAYOUTS USING A MULTI-DOMAIN DIFFUSION NEURAL NETWORK

(71) Applicant: Adobe Inc., San Jose, CA (US)

(72) Inventors: Zhaowen Wang, San Jose, CA (US); Nanxuan Zhao, San Jose, CA (US); Jimei Yang, Merced, CA (US); Difan Liu, San Jose, CA (US); Mohammad Amin Shabani, Vancouver (CA)

(21) Appl. No.: 18/641,137

(22) Filed: Apr. 19, 2024

(51) Int. Cl. G06T 11/60

(52) U.S. Cl. CPC G06T 11/60; G06T 2200/24; G06T 2210/12

(57) ABSTRACT

The present disclosure relates to systems, methods, and non-transitory computer readable media that generate layouts for digital designs from image elements via multi-domain diffusion. For instance, in some embodiments, the disclosed systems receive, from a client device, a plurality of image elements for generating a digital design. The disclosed systems generate, using an encoder of a multi-domain diffusion neural network, embeddings representing visual characteristics and bounding box characteristics of the plurality of image elements. The disclosed systems further generate, using the multi-domain diffusion neural network, a layout for the digital design from the visual characteristics and bounding box characteristics of the embeddings. Additionally, the disclosed systems provide the layout for display on the client device.

### BACKGROUND

Recent years have seen significant advancement in hardware and software platforms for generating digital designs. Indeed, as the use of digital designs have become increasingly ubiquitous, systems have developed to facilitate the creation of such digital designs. For instance, some conventional systems provide or implement tools—such as computer-implemented models—that generate various attributes (e.g., layout attributes) of a digital design. Despite these advancements, conventional design generation systems fail to flexibly generate complete design layouts that incorporate the visual information of the included image elements, often leading to aesthetically displeasing results that suffer from low saliency reasoning and low diversity.

### SUMMARY

One or more embodiments described herein provide benefits and/or solve one or more of the foregoing or other problems in the art with systems, methods, and non-transitory computer-readable media that employs a diffusion framework to flexibly generate digital design layouts that incorporate visual information of the corresponding elements. Indeed, some embodiments, the disclosed systems use latent space to perform meaningful transformations and manipulations via diffusion in generating design layouts. In some cases, the disclosed systems use the visual characteristics of the input elements as conditions for the diffusion process. Further, in some instances, the disclosed systems employ a model that performs diffusion in multiple domains (e.g., an image domain and a vector domain). For example, in certain embodiments, the model includes a diffusion branch for each domain, and the disclosed systems use the branches to generate multi-domain layout output from multi-domain input. In this manner, the disclosed systems generate design layouts with improved diversity and saliency reasoning.

Additional features and advantages of one or more embodiments of the present disclosure are outlined in the following description.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a multi-domain layout generation system operates in accordance with one or more embodiments;

FIG. 2 illustrates an overview diagram of the multi-domain layout generation system generating a layout for a digital design from image elements in accordance with one or more embodiments;

FIGS. 3A-3C illustrate the multi-domain layout generation system generating and providing layouts for a digital design in accordance with one or more embodiments;

FIGS. 4A-4C illustrates the multi-domain layout generation system generating a layout for a digital design using a style template in accordance with one or more embodiments;

FIG. 5 illustrates the multi-domain layout generation system using a multi-domain diffusion neural network to generate layouts for a digital design from image elements in accordance with one or more embodiments;

FIGS. 6A-6B illustrate architectures of a multi-domain diffusion neural network used by the multi-domain layout generation system to generate layouts based on an exchange of information between domains in accordance with one or more embodiments;

FIG. 7 illustrates a table reflecting experimental results regarding the effectiveness of the multi-domain layout generation system in accordance with one or more embodiments;

FIG. 8 illustrates the multi-domain layout generation system using a multi-domain diffusion neural network to generate a layout via style transfer in accordance with one or more embodiments;

FIG. 9 illustrates qualitative results showing the effectiveness of the multi-domain layout generation system in generating layouts via style transfer in accordance with one or more embodiments;

FIG. 10 illustrates an example schematic diagram of an image segment labeling system in accordance with one or more embodiments;

FIG. 11 illustrates a flowchart of a series of acts for using a multi-domain diffusion neural network to generate a layout for a digital design from image elements in accordance with one or more embodiments; and

FIG. 12 illustrates a block diagram of an exemplary computing device in accordance with one or more embodiments.

### DETAILED DESCRIPTION

One or more embodiments described herein include a multi-domain layout generation system that generates design layouts from image elements using a diffusion framework. In particular, in some embodiments, the multi-domain layout generation system uses a diffusion neural network that generates design layouts that incorporate visual information from the image elements used as input. In some embodiments, the diffusion neural network includes a multi-domain network that includes multiple branches, each performing diffusion in a different domain (e.g., an image domain or a vector domain). Thus, in some cases, the diffusion neural network generates layouts in multiple domains. In some instances, the branches exchange information as part of the diffusion process to enable the generation of layouts that incorporate the inputs of each domain. Further, in some implementations, the multi-domain layout generation system adapts the architecture of the diffusion neural network to incorporate the input image elements within the style of a template via a diffusion-based style transfer process.

To illustrate, in one or more embodiments, the multi-domain layout generation system receives, from a client device, a plurality of image elements for generating a digital design. The multi-domain layout generation system generates, using an encoder of a multi-domain diffusion neural network, embeddings representing visual characteristics and bounding box characteristics of the plurality of image elements. Further, the multi-domain layout generation system generates, using the multi-domain diffusion neural network, a layout for the digital design from the visual characteristics and bounding box characteristics of the embeddings. The multi-domain layout generation system provides the layout for display on the client device.

As just indicated, in one or more embodiments, the multi-domain layout generation system generates layouts for digital designs. In particular, in some embodiments, the multi-domain layout generation system generates layouts that incorporate various image elements into a visual arrangement. In some cases, the multi-domain layout generation system processes a set of input image elements to generate one or more layouts.

Additionally, as mentioned, in one or more embodiments, the multi-domain layout generation system uses a multi-domain diffusion neural network to generate layouts for digital designs. To illustrate, in some embodiments, the multi-domain layout generation system uses an encoder of the multi-domain diffusion neural network to generate embeddings from the input image elements and further uses other components of the multi-domain diffusion neural network to generate one or more layouts from the embeddings. In certain instances, the embeddings represent visual characteristics and/or bounding box characteristics of the input image elements. As such, in some cases, the resulting layouts incorporate the visual characteristics and the bounding box characteristics of the input image elements.

In some implementations, the multi-domain diffusion neural network includes multiple branches—such as an image diffusion branch and a vector diffusion branch—where each branch performs diffusion for the corresponding domain. Thus, in certain embodiments, the multi-domain layout generation system uses domain-specific noise inputs in addition to the input image elements and generates domain-specific outputs. For example, in some cases, the multi-domain layout generation system uses an image domain noise input to generate an image domain layout via the image diffusion branch and uses a vector domain noise input to generate a vector domain layout via the vector diffusion branch.

In some embodiments, the multi-domain diffusion neural network exchanges information between its branches when processing inputs to generate layouts. For instance, in some cases, the multi-domain diffusion neural network exchanges information at the condition level or the feature level. Thus, in certain implementations, the multi-domain layout generation system generates layouts from information corresponding to multiple domains.

Further, in one or more embodiments, the multi-domain layout generation system uses the multi-domain diffusion neural network to execute a style transfer process. In particular, the multi-domain layout generation system adapts the architecture of the multi-domain diffusion neural network to process a style template in addition to the input image elements and generate a layout that incorporates one or more image elements into the style of the style template.

As mentioned above, conventional design generation systems suffer from several technological shortcomings that result in inflexible operation. For instance, many conventional systems are inflexible in that they fail to incorporate visual information when generating design layouts. Indeed, conventional systems predominately concentrate on the generation of certain layout attributes, such as size and position of the image elements, without considering the corresponding visual characteristics. As these systems predominately omit visual characteristics from their processing, they tend to also produce outputs that fail to incorporate such visual characteristics. Indeed, conventional systems typically output size and position attributes rather than complete layout designs. In other words, many conventional systems generate layouts composed of bounding boxes for the image elements rather than a completed image portraying in the image elements in the determined layout.

By failing to incorporate visual characteristics, conventional systems often produce layouts with poor saliency reasoning. For instance, by failing to incorporate visual characteristics, conventional systems risk producing layouts where an important region of one image element is blocked by another image element. Further, conventional systems risk placing text over an image element that renders the text difficult to read (e.g., due to similar colors or a busy pattern). Additionally, by focusing layout generation on a particular set of attributes that omit visual characteristics, conventional systems often fail to generate diverse sets of layouts.

The multi-domain layout generation system provides several advantages over conventional systems. For instance, the multi-domain layout generation system improves the flexibility of implementing computing devices when compared to conventional systems. Indeed, by incorporating the visual characteristics of input image elements into the layout generation process, one or more embodiments of the multi-domain layout generation system generate layouts that incorporate these visual characteristics. For example, some embodiments of the multi-domain layout generation system generate image domain layouts that include a digital image portraying one or more image elements in an arrangement. In other words, one or more embodiments of the multi-domain layout generation system generate complete layouts that incorporate attributes other than (or in addition to) size and position attributes.

By incorporating visual characteristics, one or more embodiments of the multi-domain layout generation system further generate layouts with improved diversity and saliency reasoning when compared to conventional systems. Indeed, implementations of the multi-domain layout generation system use improved visual awareness to arrange image elements in accordance with areas of visual prominence to ensure crucial element portions are not obscured by other image elements. Additionally, by generating layouts in multiple domains and exchanging information between the domains, embodiments of the multi-domain layout generation system improve the layouts produced in both domains (e.g., improves their diversity and saliency reasoning). In particular, by performing diffusion via multiple interfacing domains-such as an image domain and vector domain, embodiments of the multi-domain layout generation system leverage the various advantages of those domains, which includes saliency reasoning and diversity as well as faithfulness to the input image elements.

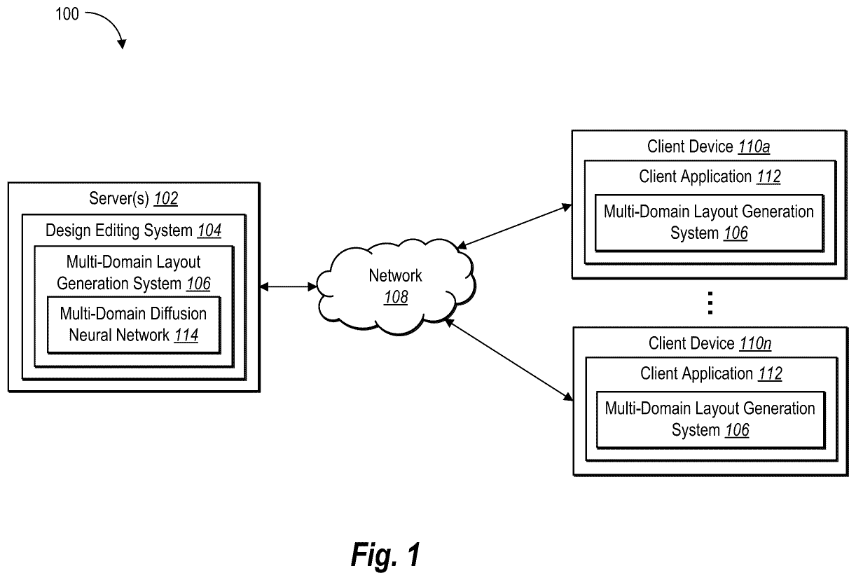

Additional details regarding the multi-domain layout generation system will now be provided with reference to the figures. For example, FIG. 1 illustrates a schematic diagram of an exemplary system environment (“environment”) 100 in which a multi-domain layout generation system 106 operates. As illustrated in FIG. 1, the environment 100 includes a server(s) 102, a network 108, and client devices 110a-110n.

Although the environment 100 of FIG. 1 is depicted as having a particular number of components, the environment 100 is capable of having any number of additional or alternative components (e.g., any number of servers, client devices, or other components in communication with the image segment classification system via the network 108). Similarly, although FIG. 1 illustrates a particular arrangement of the server(s) 102, the network 108, and the client devices 110a-110n, various additional arrangements are possible.

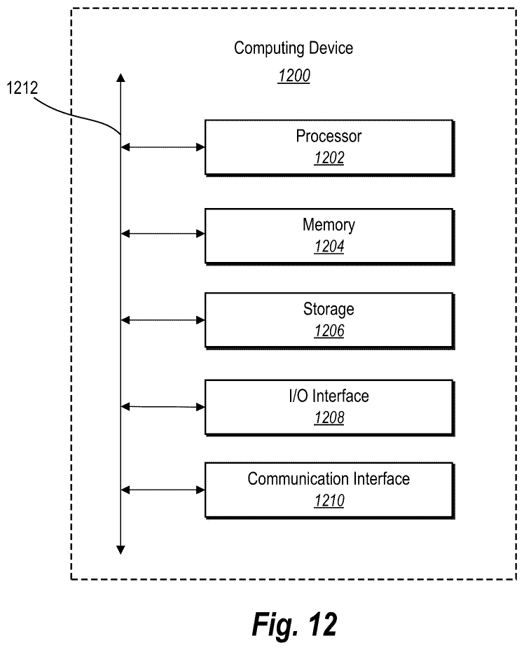

The server(s) 102, the network 108, and the client devices 110a-110n are communicatively coupled with each other either directly or indirectly (e.g., through the network 108 discussed in greater detail below in relation to FIG. 12). Moreover, the server(s) 102 and the client devices 110a-110n include one of a variety of computing devices (including one or more computing devices as discussed in greater detail with relation to FIG. 12).

As mentioned above, the environment 100 includes the server(s) 102. In one or more embodiments, the server(s) 102 generates, stores, receives, and/or transmits data including image elements and/or digital designs with generated layouts. In one or more embodiments, the server(s) 102 comprises a data server. In some implementations, the server(s) 102 comprises a communication server or a web-hosting server.

In one or more embodiments, the design editing system 104 provides functionality by which a client device (e.g., a user of one of the client devices 110a-110n) generates, edits, manages, and/or stores digital designs. For example, in some instances, a client device sends a digital design to the design editing system 104 hosted on the server(s) 102 via the network 108. The design editing system 104 then provides many options that the client device may use to edit the digital design, store the digital design, and subsequently search for, access, and view the digital design. For instance, in some cases, the design editing system 104 provides one or more options that the client device may use to generate a layout for a digital design from a plurality of image elements.

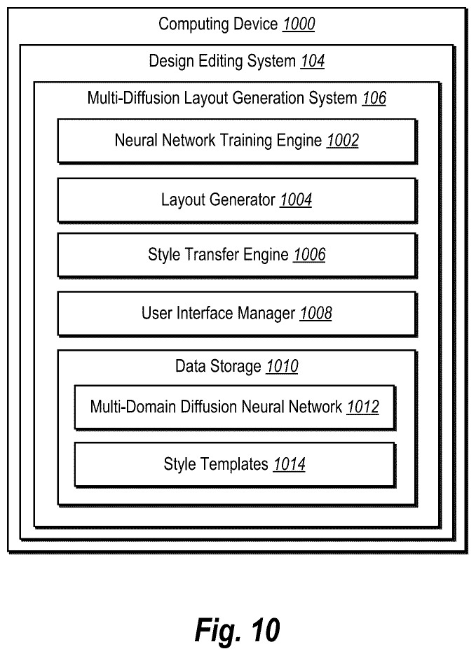

Additionally, the server(s) 102 includes the multi-domain layout generation system 106. In one or more embodiments, via the server(s) 102, the multi-domain layout generation system 106 generates a layout for a digital design from a plurality of image elements using a multi-domain diffusion neural network. For instance, in some cases, the multi-domain layout generation system 106, via the server(s) 102, uses an encoder of a multi-domain diffusion neural network to generate embeddings that represent visual characteristics and bounding box characteristics of a plurality of image elements. Via the server(s) 102, the multi-domain layout generation system 106 further uses the multi-domain diffusion neural network to generate a layout for a digital design from the visual characteristics and bounding box characteristics. Example components of the multi-domain layout generation system 106 will be described below with regard to FIG. 10.

In one or more embodiments, the client devices 110a-110n include computing devices that can access, edit, implement, modify, store, and/or provide, for display, digital designs. For example, in some embodiments, the client devices 110a-110n include smartphones, tablets, desktop computers, laptop computers, head-mounted-display devices, or other electronic devices. The client devices 110a-110n include one or more applications (e.g., the client application 112) that can access, edit, implement, modify, store, and/or provide, for display, digital designs. For example, in some embodiments, the client application 112 includes a software application installed on the client devices 110a-110n. In other cases, however, the client application 112 includes a web browser or other application that accesses a software application hosted on the server(s) 102.

One or more embodiments of the multi-domain layout generation system 106 are implemented in whole, or in part, by the individual elements of the environment 100. Indeed, as shown in FIG. 1, one or more embodiments of the multi-domain layout generation system 106 are implemented with regard to the server(s) 102 and/or at the client devices 110a-110n. In particular embodiments, the multi-domain layout generation system 106 on the client devices 110a-110n comprises a web application, a native application installed on the client devices 110a-110n (e.g., a mobile application, a desktop application, a plug-in application, etc.), or a cloud-based application where part of the functionality is performed by the server(s) 102.

In additional or alternative embodiments, the multi-domain layout generation system 106 on the client devices 110a-110n represents and/or provides the same or similar functionality as described herein in connection with the multi-domain layout generation system 106 on the server(s) 102. In some implementations, the multi-domain layout generation system 106 on the server(s) 102 supports the multi-domain layout generation system 106 on the client devices 110a-110n.

For example, in some embodiments, the multi-domain layout generation system 106 on the server(s) 102 trains one or more machine learning models described herein (e.g., the multi-domain diffusion neural network 114). The multi-domain layout generation system 106 on the server(s) 102 provides the one or more trained machine learning models to the multi-domain layout generation system 106 on the client devices 110a-110n for implementation. Accordingly, although not illustrated, in one or more embodiments, the multi-domain layout generation system 106 on the client devices 110a-110n uses the one or more trained machine learning models to generate layouts from image elements independent from the server(s) 102.

In some embodiments, the multi-domain layout generation system 106 includes a web hosting application that allows the client devices 110a-110n to interact with content and services hosted on the server(s) 102. To illustrate, in one or more implementations, the client devices 110a-110n accesses a web page or computing application supported by the server(s) 102. The client devices 110a-110n provide input to the server(s) 102, such as image elements. In response, the multi-domain layout generation system 106 on the server(s) 102 utilizes the provided input to generate one or more layouts for a digital design. The server(s) 102 then provides the layout(s) generated from the image elements to the client devices 110a-110n.

In some embodiments, though not illustrated in FIG. 1, the environment 100 has a different arrangement of components and/or has a different number or set of components altogether. For example, in certain embodiments, the client devices 110a-110n communicate directly with the server(s) 102 bypassing the network 108. As another example, the environment 100 includes a third-party server comprising a content server and/or a data collection server.

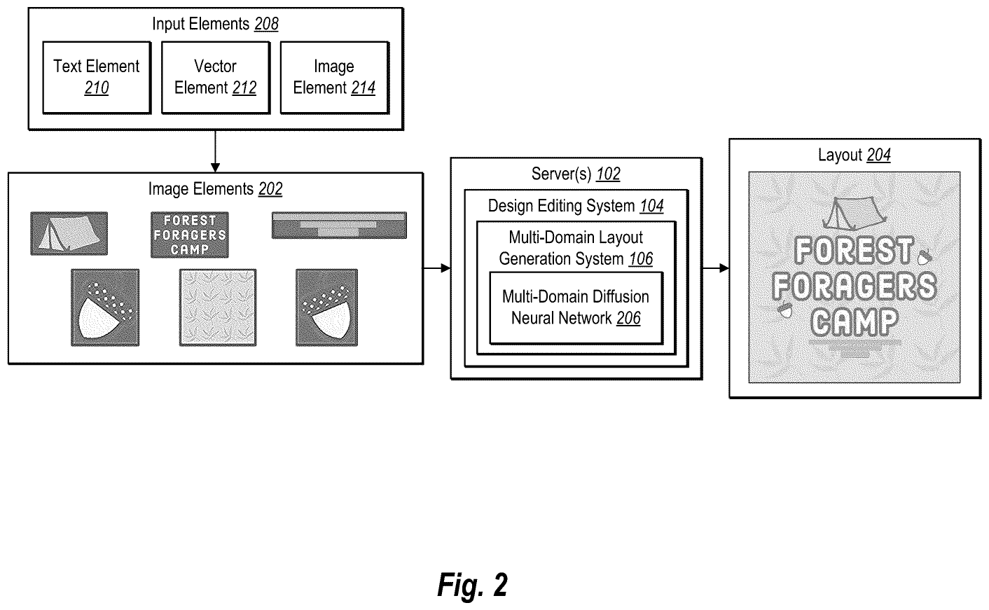

As mentioned, in one or more embodiments, the multi-domain layout generation system 106 generates a layout for a digital design from a plurality of image elements. FIG. 2 illustrates an overview diagram of the multi-domain layout generation system 106 generating a layout for a digital design from image elements in accordance with one or more embodiments.

In one or more embodiments, a digital design includes a design of digital visual content. In particular, in some embodiments, a digital design includes a digital representation of a visual design. Some examples of a digital design include, but are not limited to, a drawing, a chart, a map, a graph, a logo or other graphic, a digital image, or a combination such designs. In some cases, a digital design includes a digitally created design (e.g., a design created using software tools). For example, in certain embodiments, a digital design includes a design (e.g., artwork) composed of raster graphics or vector graphics. In some implementations, however, a digital design includes a digital re-creation of a real-world design (e.g., a scan or digital image of the design).

As will be discussed herein, in one or more embodiments, a digital design includes and/or is generated from one or more image elements. In one or more embodiments, an image element includes a distinct element of visual digital content having one or more visual characteristics. Indeed, in some embodiments, an image element includes an element of digital visual content that is separately identifiable from other elements of digital visual content. For instance, in some cases, an image element includes an element of digital visual content that is modifiable separately from other elements of digital visual content. Indeed, as will be discussed further, in certain implementations, an image element includes or is delineated by a bounding box that is distinct from the bounding boxes of other image elements. Some examples of an image element include, but are not limited to, a character of text, a segment of text, a shape or collection of shapes, a digital image or portion of a digital image, a background, a color, or a border. In some cases, an image element includes a rendered image. For example, in some instances, an image element includes a rendered digital image or portion of a rendered digital image. In some implementations, however, the multi-domain layout generation system 106 uses image elements rendered as images from objects or graphics of other modalities. For example, in some embodiments, an image element includes a text image generated from a text object where a visual characteristic of the text object includes the associated font or color of text. As another example, in some instances, an image element includes a vector image generated from a scalable vector graphic (SVG). In other words, as will be illustrated below, various implementations of the multi-domain layout generation system 106 use image elements generated from various modalities. In some implementations, the multi-domain layout generation system 106 generates an image element from an object or graphic of another modality (e.g., uses a text engine to render a text object as a text image).

As will further be discussed, in one or more embodiments, a digital design includes a layout. In one or more embodiments, a layout includes an arrangement of image elements within a digital design. In particular, in some embodiments, a layout includes a configuration of layering, sizing, and/or positioning of the image elements included in a digital design. As will be discussed below, in some cases, a layout (and the associated digital design) includes one or more features based on a domain in which the layout was created. Indeed, as will be discussed, in some cases, a layout includes an image domain layout or a vector domain layout.

Indeed, FIG. 2 illustrates the multi-domain layout generation system 106 receiving, retrieving, or otherwise accessing image elements 202 for generating a layout for a digital design. For instance, in one or more embodiments, the multi-domain layout generation system 106 receives the image elements 202 from a client device. As shown, in some cases, the image elements 202 are received, retrieved, or otherwise accessed as separated image elements having no arrangement. For example, in some instances, the image elements 202 are received as input by being positioned on a blank canvas. In some cases, however, the image elements 202 are arranged in a layout, such as a layout resulting from a prior attempt to generate a digital design.

As shown in FIG. 2, in some cases, the multi-domain layout generation system 106 generates the image elements 202 from input elements 208. For instance, in some cases, the multi-domain layout generation system 106 receives the input elements 208 from a client device and generates the image elements 202 upon receiving the input elements 208. As indicated by FIG. 2, in one or more implementations, an input element includes a text element 210 or a vector element 212. In some embodiments, the multi-domain layout generation system 106 generates an image element from an input element by rendering the input element as an image using a corresponding rendering engine. For example, in some cases, the multi-domain layout generation system 106 generates an image element from a text element by rendering the text element as an image using a text engine or generates an image element from a vector element by rendering the vector element as an image using a vector engine.

As further indicated by FIG. 2, in some implementations, an input element includes an image element 214. In particular, in some cases, an input element includes an element that has already been rendered as an image. As such, in some cases, the multi-domain layout generation system 106 does not create an image element from the input element. Rather, the multi-domain layout generation system 106 uses the image element directly. It should be understood, that while FIG. 2 illustrates particular input elements, the multi-domain layout generation system 106 generates/uses image elements from various input elements in various implementations. For instance, while FIG. 2 specifically indicate image elements and vector elements, various other graphic elements are used in various embodiments. Because the multi-domain layout generation system 106 generates image elements from input elements (e.g., where an input element does not already include a rendered image), the terms input element and image element are used interchangeably herein.

As further shown in FIG. 2, the multi-domain layout generation system 106 generates a layout 204 from the image elements 202. In particular, the multi-domain layout generation system 106 generates the layout 204 for use in a digital design. Indeed, as shown, the layout 204 includes the image elements 202 in an arrangement. While FIG. 2 shows the layout 204 including every image element from the image elements 202, in some implementations, the layout generated by the multi-domain layout generation system 106 includes additional image elements, alternative image elements, and/or a subset of those image elements used as input.

As FIG. 2 shows, the multi-domain layout generation system 106 uses a multi-domain diffusion neural network 206 to generate the layout 204 from the image elements 202. In one or more embodiments, a neural network includes a type of machine learning model, which can be tuned (e.g., trained) based on inputs to approximate unknown functions used for generating the corresponding outputs. In particular, in some embodiments, a neural network includes a model of interconnected artificial neurons (e.g., organized in layers) that communicate and learn to approximate complex functions and generate outputs based on inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial network, a graph neural network, a multi-layer perceptron, or a diffusion neural network. In some embodiments, a neural network includes a combination of neural networks or neural network components.

In one or more embodiments, a multi-domain diffusion neural network includes a computer-implemented neural network that generates layouts for digital designs from image elements. In particular, in some embodiments, a multi-domain diffusion neural network includes a neural network that performs diffusion to generate layouts from image elements. For instance, as will be discussed below, in certain embodiments, a multi-domain diffusion neural network uses image elements in generating one or more conditions that guide the diffusion process. Further, in some cases, a multi-domain diffusion neural network includes multiple branches, where each branch corresponds to a different domain and performs diffusion in that domain.

Indeed, as will be discussed below, in some cases, the multi-domain layout generation system 106 uses the multi-domain diffusion neural network 206 to perform diffusion in an image domain and a vector domain. In some cases, an image domain includes the domain of image processing/generation that focuses on the visual characteristics of a digital image. By contrast, in some embodiments, a vector domain includes the domain of image processing/generation that focuses on the bounding box characteristics of a digital image. Visual characteristics and bounding box characteristics will be discussed in more detail below.

Thus, in one or more implementations, the multi-domain layout generation system 106 uses the multi-domain diffusion neural network 206 to process the image elements 202 in multiple domains. Additionally, as will be discussed, in certain embodiments, the multi-domain layout generation system 106 further uses the multi-domain diffusion neural network 206 to generate layouts for a digital design in multiple domains.

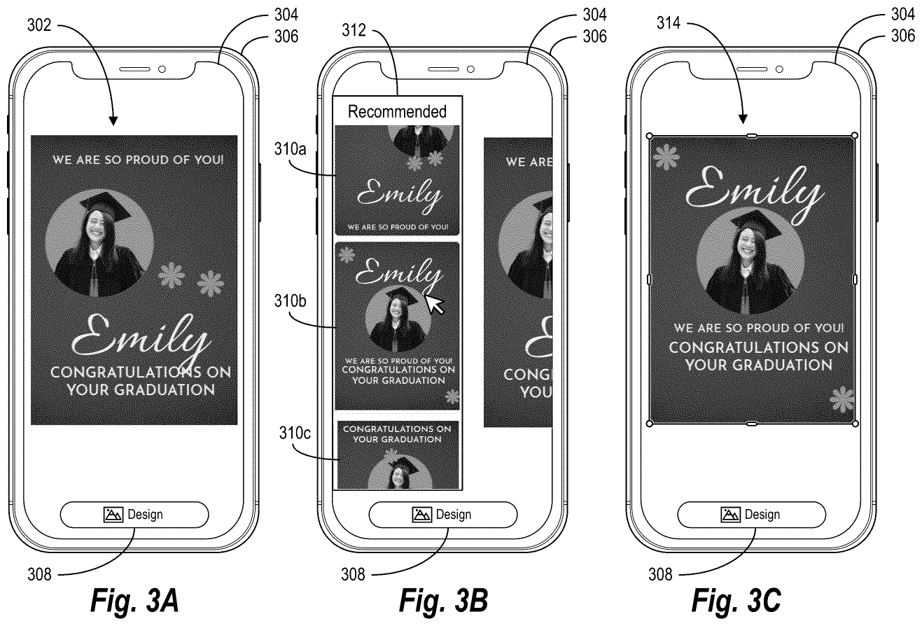

As just discussed, in one or more embodiments, the multi-domain layout generation system 106 generates one or more layouts for a digital design from image elements. For instance, in some cases, the multi-domain layout generation system 106 receives a plurality of image elements from a client device, generates one or more layouts from the plurality of image elements, and provides the layout(s) for display on the client device. FIGS. 3A-3C illustrate the multi-domain layout generation system 106 generating and providing layouts for a digital design in accordance with one or more embodiments.

Indeed, FIG. 3A illustrates the multi-domain layout generation system 106 providing a plurality of image elements 302 (e.g., input elements that have been rendered as images) for display within a graphical user interface 304 of a client device 306. In some cases, the multi-domain layout generation system 106 provides the plurality of image elements 302 in response to user interactions with the client device 306 that select or otherwise identify the plurality of image elements 302 for use in generating a digital design. As shown, the plurality of image elements 302 includes a portion of a digital image, multiple shapes, several segments of text, and a background color.

As further shown, the plurality of image elements 302 are arranged on a canvas (with the background color being applied to the canvas). In some cases, the multi-domain layout generation system 106 arranges the plurality of image elements 302 on the canvas as shown in response to user input indicating the arrangement. For example, in some implementations, the multi-domain layout generation system 106 arranges the plurality of image elements 302 on the canvas in response to user interactions for manually generating a layout for the digital design.

Additionally, as illustrated, the multi-domain layout generation system 106 provides a selectable option 308 for display within the graphical user interface 304. In one or more embodiments, the multi-domain layout generation system 106 provides the selectable option 308 for use in triggering the generation of one or more layouts for the digital design. For instance, in some cases, the multi-domain layout generation system 106 generates one or more layouts from the plurality of image elements 302 on the canvas in response to detecting a user interaction selecting the selectable option 308.

Indeed, as shown in FIG. 3B, the multi-domain layout generation system 106 generates and provides layouts 310a-310c for display within the graphical user interface 304. Further, the multi-domain layout generation system 106 generates and provides a recommendation panel 312 that portrays the layouts 310a-310c. To illustrate, in some embodiments, in response to detecting a user selection of the selectable option 308, the multi-domain layout generation system 106 uses a multi-domain diffusion neural network to generate the layouts 310a-310c from the plurality of image elements 302. For example, in certain instances, the multi-domain layout generation system 106 uses the multi-domain diffusion neural network to generate at least one image domain layout and/or at least one vector domain layout. The multi-domain layout generation system 106 further provides the layouts 310a-310c generated via the multi-domain diffusion neural network for display within the recommendation panel 312 portrayed in the graphical user interface 304.

Thus, in some cases, in response to a selection of the selectable option 308, the multi-domain layout generation system 106 generates recommended layouts (e.g., the layouts 310a-310c) for the digital design. As indicated by FIG. 3B, the multi-domain layout generation system 106 generates and provides the recommended layouts by generating and providing recommended digital designs having the recommended layouts. The multi-domain layout generation system 106, however, generates and provides recommended layouts in various formats in various implementations. For instance, in some cases, the multi-domain layout generation system 106 generates and provides maps for the recommended layouts, where a map indicates the position of each image element on the canvas without providing the digital design resulting from the positions.

FIG. 3C illustrates the multi-domain layout generation system 106 providing a digital design 314 having a layout for display within the graphical user interface 304. In some cases, the multi-domain layout generation system 106 provides the digital design 314 in response to detecting a user selection of a recommended layout (e.g., the layout 310b portrayed in the recommendation panel 312 of FIG. 3B). In some implementations, such as where the multi-domain layout generation system 106 provides recommended layouts without providing the resulting digital designs, the multi-domain layout generation system 106 further generates the digital design 314 in response to detecting a user selection of the recommended layout.

Thus, the multi-domain layout generation system 106 enables user interactions with a client device to trigger the generation and provision of one or more layouts for a digital design. Indeed, in some cases, the multi-domain layout generation system 106 provides an efficient graphical user interface in which a small set of user interactions triggers the generation of multiple recommended layouts from a set of image elements.

In certain implementations, the multi-domain layout generation system 106 further modifies the digital design 314 (e.g., the layout of the digital design) in response to additional user interactions. For instance, in some cases, the multi-domain layout generation system 106 adds image elements to or removes image elements from the digital design 314. Further, in some instances, the multi-domain layout generation system 106 modifies the positioning, size, and/or layering of one or more of the image elements included in the digital design 314. In some embodiments, upon detecting an additional user interaction selecting the selectable option 308 after modifying the digital design 314, the multi-domain layout generation system 106 generates and provides additional recommended layouts for the digital design 314. Thus, in some implementations, the multi-domain layout generation system 106 enables an iterative process in which a digital design is manually manipulated via user interaction, and the multi-domain layout generation system 106 generates layouts for the digital design based on those manipulations.

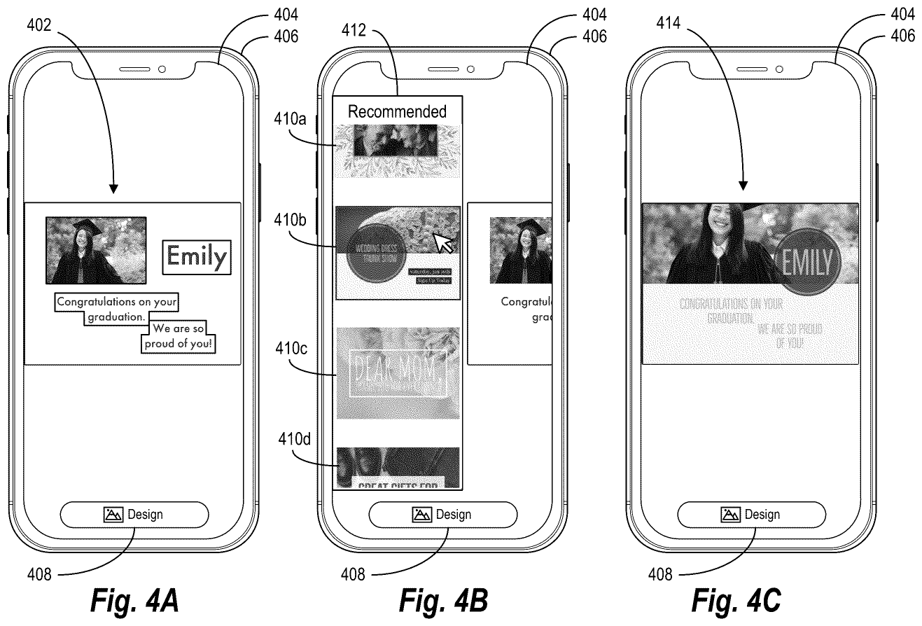

As further discussed, in some embodiments, the multi-domain layout generation system 106 generates one or more layouts for a digital design via style transfer. In particular, in some cases, the multi-domain layout generation system 106 generates the layout(s) from a set of image elements using a style template. FIGS. 4A-4C illustrates the multi-domain layout generation system 106 generating a layout for a digital design using a style template in accordance with one or more embodiments.

For instance, FIG. 4A illustrates the multi-domain layout generation system 106 providing a plurality of image elements 402 (e.g., input elements that have been rendered as images) for display within a graphical user interface 404 of a client device 406. As shown, the multi-domain layout generation system 106 provides the plurality of image elements 402 on a blank canvas. For instance, in some cases, the multi-domain layout generation system 106 provides the plurality of image elements 402 in response to user interactions positioning the plurality of image elements 402 on the blank canvas.

As further shown in FIG. 4A, the multi-domain layout generation system 106 also provides a selectable option 408 for display within the graphical user interface 404. In one or more embodiments, the multi-domain layout generation system 106 provides the selectable option 408 for use in triggering the generation of one or more layouts for the digital design. For instance, in some cases, the multi-domain layout generation system 106 generates one or more layouts from the plurality of image elements 402 via style transfer in response to detecting a user interaction selecting the selectable option 408.

Indeed, as shown in FIG. 4B, the multi-domain layout generation system 106 provides style templates 410a-410d for display within the graphical user interface 404. Further, the multi-domain layout generation system 106 generates and provides a recommendation panel 412 that portrays the style templates 410a-410d. For example, in some cases, the multi-domain layout generation system 106 provides the recommendation panel 412 portraying the style templates 410a-410d for display upon detecting a user interaction selecting the selectable option 408.

In one or more embodiments, a style template includes a template for generating a digital design using a particular style represented by the style template. For instance, in some cases, a style template includes a template for generating a layout of a digital design, where the template indicates a positioning, a layering, and/or a sizing for the image elements incorporated within the digital design. In some implementations, however, a style template includes a template for adding, removing, and/or modifying image elements selected for use in generating a digital design. For example, in certain embodiments, a style input includes a template indicating a cropping for one or more image elements, a change in color or contrast, or a change in the font of text. In other words, in one or more embodiments, a style template includes a template that provides an overall visual to be applied to a digital design, and the multi-domain layout generation system 106 generates a layout for a digital design to include the visual aesthetic of the style template.

FIG. 4C illustrates the multi-domain layout generation system 106 providing a digital design 414 having a layout for display within the graphical user interface 404. In some cases, the multi-domain layout generation system 106 generates and provides the digital design 414 in response to detecting a user selection of a style template (e.g., the style template 410b portrayed in the recommendation panel 412 of FIG. 4B). Further, in some implementations, the multi-domain layout generation system 106 generates the digital design 414 using a multi-domain diffusion neural network. Indeed, as will be discussed below, in some cases, the multi-domain layout generation system 106 adapts the architecture of a multi-domain diffusion neural network to generate the digital design 414 having the layout from the plurality of image elements 402 and the selected style template.

As indicated, the multi-domain layout generation system 106 does not generate the digital design 414 to mimic the exact configuration of the selected style template such that the position, sizing, and layering of each image element in the digital design 414 matches the position, sizing, and layering of each image element from the selected style template. Rather, as shown, the multi-domain layout generation system 106 generates the digital design 414 to mimic the visual aesthetic of the selected style template more generally. In some implementations, however, the multi-domain layout generation system 106 does generate a digital design to mimic the configuration of the selected style template more strictly.

Thus, the multi-domain layout generation system 106 enables user interactions with a client device to trigger the generation and provision of one or more layouts for a digital design based on a style template. Indeed, in some cases, the multi-domain layout generation system 106 provides an efficient graphical user interface in which a small set of user interactions triggers a style transfer process by which a set of input image elements are used to generate a layout for a digital design that mimics the visual aesthetic of a style template.

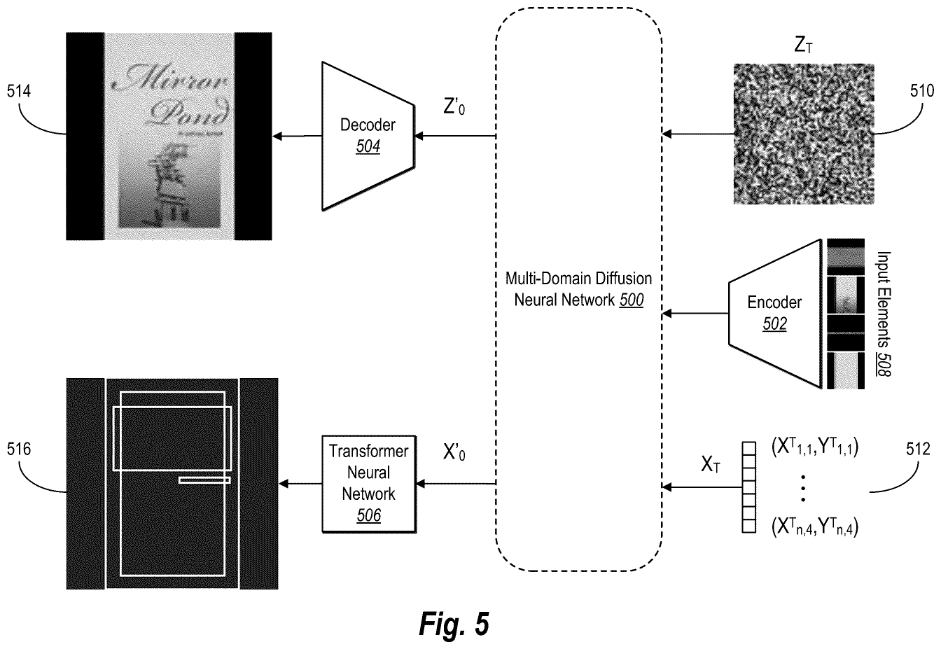

As mentioned, in one or more embodiments, the multi-domain layout generation system 106 uses a multi-domain diffusion neural network to generate one or more layouts for a digital design from a plurality of image elements. For instance, in some cases, upon detecting a user interaction for generating one or more layouts from a plurality of image elements via a graphical user interface, the multi-domain layout generation system 106 employs a multi-domain diffusion neural network to generate the layout(s). FIG. 5 illustrates the multi-domain layout generation system 106 using a multi-domain diffusion neural network to generate layouts for a digital design from image elements in accordance with one or more embodiments.

Indeed, FIG. 5 illustrates a multi-domain diffusion neural network 500 used by the multi-domain layout generation system 106 to generate layouts for a digital design. The multi-domain diffusion neural network 500 includes various components that will be discussed in more detail below. FIG. 5 also illustrates an encoder 502, a decoder 504, and a transformer neural network 506. Though FIG. 5 portrays these additional components as separate from the multi-domain diffusion neural network 500, it should be understood that the encoder 502, the decoder 504, and the transformer neural network 506 are included as part of the multi-domain diffusion neural network 500 in some implementations.

As illustrated by FIG. 5, the multi-domain layout generation system 106 determines image elements 508 (e.g., input elements that have been rendered as images) to use in generating the layouts for the digital design and provides the image elements 508 to the encoder 502. As previously mentioned, in some cases, the multi-domain layout generation system 106 receives the image elements 508 from a client device. For instance, in some embodiments, the multi-domain layout generation system 106 receives the image elements 508 via user interactions with a graphical user interface of a client device.

As shown, the multi-domain layout generation system 106 provides the output of the encoder 502 to the multi-domain diffusion neural network 500. In one or more embodiments, the multi-domain layout generation system 106 uses the encoder 502 to capture, within its output, visual characteristics and/or bounding box characteristics of the image elements 508. In particular, in some embodiments, the multi-domain layout generation system 106 uses the encoder 502 to capture, within its output, one or more visual characteristics and/or one or more bounding box characteristics of each image element from the image elements 508. Thus, in some instances, the multi-domain layout generation system 106 uses the multi-domain diffusion neural network 500 to generate layouts for the digital design from the visual characteristics and/or the bounding box characteristics of the image elements 508.

In one or more embodiments, the visual characteristics and bounding box characteristics of an image element include various attributes of the image element. In particular, in some embodiments, visual characteristics and bounding box characteristics include different sets of attributes of the image element. For instance, in some embodiments, the bounding box characteristics of an image element include attributes of the bounding box associated with the image element. To illustrate, in some cases, the bounding box characteristics of an image element include the location (e.g., coordinates within a canvas) and/or size of the bounding box associated with the image element. To contrast, in some implementations, the visual characteristics of an image element include visible attributes of the image element (e.g., visible attributes other than the location and/or size of its associated bounding box). In particular, in some embodiments, the visual characteristics of an image element include visual attributes of the contents of the image element. To illustrate, in some instances, the visual characteristics of an image element include objects, text, colors, hues, shadings, and/or transparency levels of the image element.

Additionally, as illustrated, the multi-domain layout generation system 106 determines an image domain noise input 510 and a vector domain noise input 512 to use in generating the layouts for the digital design. As shown, the multi-domain layout generation system 106 provides the image domain noise input 510 and the vector domain noise input 512 to the multi-domain diffusion neural network 500 as additional input.

In one or more embodiments, a noise input includes an input to a neural network (e.g., a multi-domain diffusion neural network) that includes noise. In particular, in some embodiments, a noise input includes an input to a neural network made of noise. To illustrate, in some cases, a noise input includes an input to a neural network having randomized, semi-randomized, or otherwise arbitrary values. As will be shown, in some cases, the multi-domain layout generation system 106 performs diffusion to generate layouts from one or more noise inputs.

In one or more embodiments, an image domain noise input includes a noise input for generating a layout for a digital design in an image domain. In particular, in some embodiments, an image domain noise input includes a noise input for performing diffusion in the image domain to generate a layout for a digital design. To illustrate, in some cases, an image domain noise input includes a noisy image having a noise distribution (e.g., a Gaussian distribution of noise) or having noise sampled from such a distribution (e.g., patches created from the distribution).

In one or embodiments, a vector domain noise input includes noise input for generating a layout for a digital design in a vector domain. In particular, in some embodiments, a vector domain noise input includes a noise input for performing diffusion in the vector domain to generate a layout for a digital design. To illustrate, in some cases, a vector domain noise input includes noisy bounding box locations (e.g., noisy coordinate points) and/or noisy bounding box sizes. For instance, in some instances, a vector domain noise input includes the coordinates of the corners of the bounding boxes.

As FIG. 5 illustrates, the multi-domain layout generation system 106 uses the multi-domain diffusion neural network 500 to process the image elements 508, the image domain noise input 510, and the vector domain noise input 512 and generate outputs based on the processing. In particular, FIG. 5 illustrates the multi-domain diffusion neural network 500 generating an image domain layout 514 via the decoder 504 and generating a vector domain layout 516 via the transformer neural network 506.

In one or more embodiments, an image domain layout includes a layout generated for a digital design in the image domain. In particular, in some embodiments, an image domain layout includes a layout that incorporates visual characteristics of image elements used in generating the layout. To illustrate, in some cases, an image domain layout includes a digital image that portrays one or more image elements arranged in a layout.

In one or more embodiments, a vector domain layout includes a layout generated for a digital design in the vector domain. In particular, in some embodiments, a vector domain layout includes a layout that incorporates bounding box characteristics of image elements used in generating the layout. To illustrate, in some cases, a vector domain layout includes a plurality of bounding boxes arranged in a layout on a canvas.

In certain embodiments, generating layouts in multiple domains provides advantages over generating the layouts in a single domain. For instance, in some cases, generating image domain layouts provides diverse results with high saliency reasoning while generating vector domain layouts provides results having high faithfulness to the input image elements. Indeed, as previously mentioned, in some cases, the layouts generated by the multi-domain layout generation system 106 via the multi-domain diffusion neural network 500 include the image elements used as input, a subset of those image elements, additional image elements, or even alternative image elements. Thus, in some instances, the resulting layout does not incorporate the input image elements. In other implementations, however, the resulting layout incorporates some or all of the input image elements.

Additionally, in certain instances, an image domain layout includes a static digital image. In other words, in some embodiments, to modify an image domain layout, the multi-domain layout generation system 106 employs additional editing tools. In some cases, however, a vector domain layout includes a modifiable layout. In particular, in some instances, the multi-domain layout generation system 106 modifies the without the need to employ additional editing tools. For instance, in some cases, the multi-domain layout generation system 106 modifies a vector domain layout by modifying at least one image element included in the vector domain layout. In particular, in some cases, the multi-domain layout generation system 106 modifies a bounding box of the at least one image element within the vector domain layout (e.g., by repositioning or re-sizing the bounding box). To illustrate, in some implementations, the multi-domain layout generation system 106 detects one or more user interactions with a bounding box of a vector domain layout and modifies the vector domain layout in accordance with the user interaction in response.

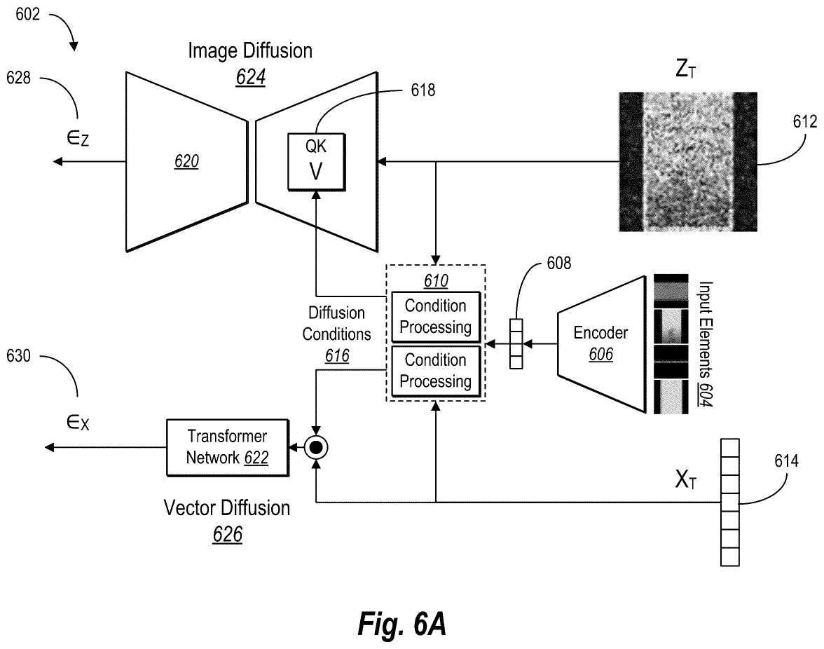

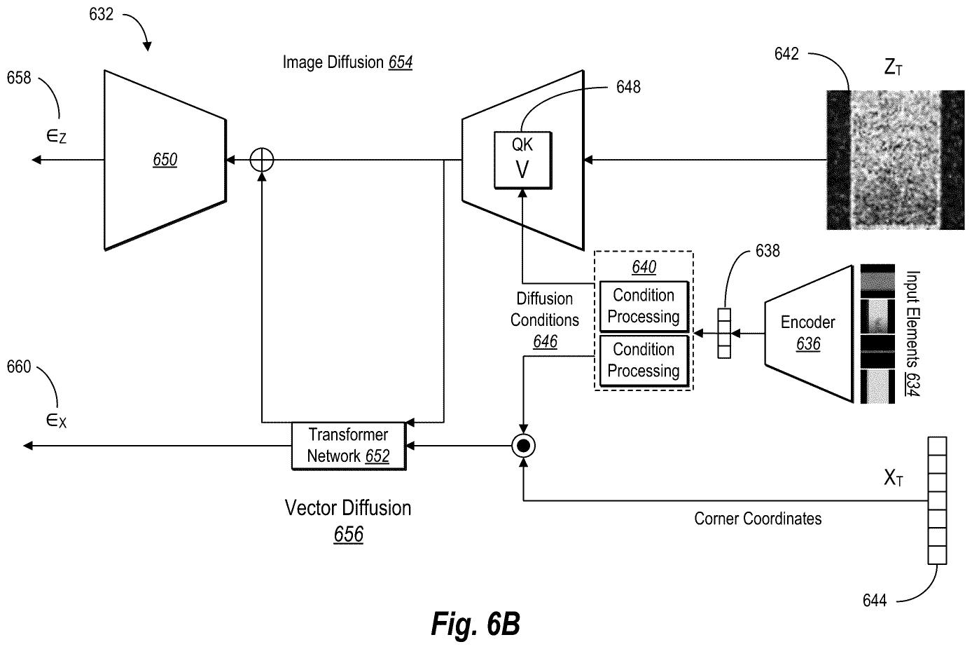

As will be explained, however, in some cases, the multi-domain layout generation system 106 uses information exchange between domains to improve the output of both domains. In particular, in some embodiments, the multi-domain layout generation system 106 uses a multi-domain diffusion neural network to exchange information between the image domain and vector domain and to perform diffusion based on the information exchange. FIGS. 6A-6B illustrate architectures of a multi-domain diffusion neural network used by the multi-domain layout generation system 106 to generate layouts based on an exchange of information between domains in accordance with one or more embodiments.

For instance, in one or more embodiments, the multi-domain layout generation system 106 uses a multi-domain diffusion neural network to generate one or more cross-domain representations of the input image elements. In one or more embodiments, a cross-domain representation includes a representation of one or more image elements generated from an exchange of information between domains. In particular, in some cases, a cross-domain representation includes a representation of one or more image elements that captures patent and/or latent attributes of the image element(s) based on an exchange of information between domains. As illustrated by FIGS. 6A-6B, various embodiments of the multi-domain layout generation system 106 generate cross-domain representations using various architectural implementations of a multi-domain diffusion neural network. In some cases, a cross-domain representation includes a diffusion condition. In some instances, a cross-domain representation includes one or more intermediate features. In some implementations, a cross-domain representation is represented as a feature map or set of feature maps.

Indeed, FIG. 6A illustrates the multi-domain layout generation system 106 using an architecture of a multi-domain diffusion neural network 602 to generate layouts based on a condition-level exchange of information in accordance with one or more embodiments. As shown, the multi-domain layout generation system 106 provides image elements 604 (e.g., input elements that have been rendered as images) to an encoder 606 (e.g., the encoder 502 discussed with reference to FIG. 5). The multi-domain layout generation system 106 uses the encoder 606 to generate embeddings 608 from the image elements 604. In one or more embodiments, the multi-domain layout generation system 106 generates the embeddings 608 to represent visual characteristics and bounding box characteristics of the image elements 604.

In one or more embodiments, the multi-domain layout generation system 106 uses, as the encoder 606 of the multi-domain diffusion neural network 602, the encoder of the variational autoencoder (VAE) of the stable diffusion model described by Robin Rombach et al., High-Resolution Image Synthesis with Latent Diffusion Models, 2022, arXiv:2112.10752v2, arXiv:2201.03545, which is incorporated herein by reference in its entirety. In some embodiments, however, the multi-domain layout generation system 106 uses, as the encoder 606, an encoder from a contrastive language-image pre-training (CLIP) model. For instance, in some cases, the multi-domain layout generation system 106 uses, as the encoder 606, the CLIP model used for the multi-domain style encoder as described in U.S. patent application Ser. No. 17/652,390 filed on Feb. 24, 2022, entitled GENERATING ARTISTIC CONTENT FROM A TEXT PROMPT OR A STYLE IMAGE UTILIZING A NEURAL NETWORK MODEL, which is incorporated herein by reference in its entirety.

As shown in FIG. 6A, the multi-domain layout generation system 106 provides the embeddings 608 generated by the encoder 606 to a condition processing block 610. As further shown, the multi-domain layout generation system 106 also provides an image domain noise input 612 and a vector domain noise input 614 to the condition processing block 610. For instance, in some cases, the multi-domain layout generation system 106 concatenates the embeddings 608, the image domain noise input 612, and the vector domain noise input 614, and provides the concatenated result to the condition processing block 610. In some cases, the multi-domain layout generation system 106 performs an element-wise concatenation. For example, in some implementations, the multi-domain layout generation system 106 concatenates an embedding generated for an image element with a vector domain noise input (e.g., noisy coordinates) for the image element and an image domain noise input (e.g., a noisy image patch) for the image element.

In one or more embodiments, the multi-domain layout generation system 106 uses a transformer neural network as the condition processing block 610. As illustrated, the multi-domain layout generation system 106 uses the condition processing block 610 to generate diffusion conditions 616 from the embeddings 608, the image domain noise input 612, and the vector domain noise input 614.

In one or more embodiments, a diffusion condition includes a value or set of values that provide guidance for one or more diffusion processes. For instance, in some cases, a diffusion condition includes a value or set of values that constrain or direct the output of a diffusion process or otherwise indicate a target for the content of the output of the diffusion process. To illustrate, in some embodiments, a diffusion condition includes a value or set of values generated from one or more conditioning inputs (e.g., embeddings of image elements, image domain noise input, and/or vector domain noise input), the value(s) directing a neural network implementing a diffusion process to generate one or more outputs based on the information provided by the conditioning input(s) (e.g., the content of the conditioning input(s)). In some implementations, a diffusion condition is represented as one or more feature maps. In some cases, a diffusion condition includes a spatial condition and/or a global condition.

By generating the diffusion conditions 616 from the encoder 606, the image domain noise input 612, and the vector domain noise input 614, the multi-domain layout generation system 106 generates a cross-domain representation of the image elements 604. Indeed, the multi-domain layout generation system 106 uses the condition processing block 610 to perform a condition-level exchange of information between the image domain and the vector domain. In particular, the multi-domain layout generation system 106 exchanges the input of each domain (e.g., the image domain noise input 612 and the vector domain noise input 614) via the condition processing block 610, resulting in diffusion conditions that incorporate information from each input. While FIG. 6A illustrates the multi-domain layout generation system 106 generating multiple diffusion conditions, it should be understood that the multi-domain layout generation system 106 generates a single diffusion condition via the condition processing block 610 in some implementations.

As indicated by FIG. 6A, the multi-domain layout generation system 106 provides the diffusion conditions 616 to each branch of the multi-domain diffusion neural network 602. Indeed, in one or more embodiments, the multi-domain layout generation system 106 uses a multi-domain diffusion neural network having multiple branches to perform diffusion in multiple domains. For instance, as illustrated, the multi-domain diffusion neural network 602 includes an image diffusion branch 624 and a vector diffusion branch 626.

In one or more embodiments, an image diffusion branch includes one or more components of a multi-domain diffusion neural network for performing diffusion in the image domain. In particular, in some embodiments, an image diffusion branch includes one or more components of a multi-domain diffusion neural network for generating an image domain layout via diffusion. To illustrate, FIG. 6A portrays the image diffusion branch including an encoder 618 and a decoder 620 (e.g., the decoder 504 discussed with reference to FIG. 5). In one or more embodiments, the encoder 618 and the decoder 620 include an encoder and decoder, respectively, of a convolutional neural network. For instance, in some embodiments, the multi-domain layout generation system 106 uses the encoder and decoder of the U-net model of the stable diffusion model described by Rombach et al. as the encoder 618 and the decoder 620, respectively.

By contrast, in some embodiments, a vector diffusion branch includes one or more components of a multi-diffusion neural network for performing diffusion in the vector domain. In particular, in some embodiments, a vector diffusion branch includes one or more components of a multi-domain diffusion neural network for generating a vector domain layout via diffusion. To illustrate, FIG. 6A portrays the vector diffusion branch including a transformer neural network 622 (e.g., the transformer neural network 506 discussed with reference to FIG. 5). In one or more embodiments, the transformer neural network 622 includes a deep neural network having a plurality of layers.

As shown in FIG. 6A, the multi-domain layout generation system 106 provides the image domain noise input 612 and the diffusion conditions 616 to the encoder 618 of the image diffusion branch 624. The multi-domain layout generation system 106 further provides the output of the encoder 618 (e.g., one or more intermediate features) to the decoder 620 of the image diffusion branch 624. The multi-domain layout generation system 106 uses the decoder 620 to generate an image domain layout 628. Thus, in some cases, the multi-domain layout generation system 106 uses the image diffusion branch 624 to generate the image domain layout 628 from the embeddings 608, the image domain noise input 612, and the vector domain noise input 614. In particular, the multi-domain layout generation system 106 uses the image diffusion branch 624 to generate the image domain layout 628 from the diffusion conditions 616 generated from the embeddings 608, the image domain noise input 612, and the vector domain noise input 614.

As further shown in FIG. 6A, the multi-domain layout generation system 106 provides the vector domain noise input 614 and the diffusion conditions 616 to the transformer neural network 622 of the vector diffusion branch 626. The multi-domain layout generation system 106 further uses the transformer neural network 622 to generate a vector domain layout 630. Thus, in some cases, the multi-domain layout generation system 106 uses the vector diffusion branch 626 to generate the vector domain layout 630 from the embeddings 608, the image domain noise input 612, and the vector domain noise input 614. In particular, the multi-domain layout generation system 106 uses the vector diffusion branch 626 to generate the vector domain layout 630 from the diffusion conditions 616 generated from the embeddings 608, the image domain noise input 612, and the vector domain noise input 614.

Though FIG. 6A portrays the image diffusion branch 624 and the vector diffusion branch 626 as separate branches that perform distinct diffusion processes in generating their respective layouts, various implementations of the multi-domain layout generation system 106 use an architecture in which the branches exchange information during the diffusion process. FIG. 6B illustrates the multi-domain layout generation system 106 using an architecture of a multi-domain diffusion neural network 632 to generate layouts based on a feature-level exchange of information in accordance with one or more embodiments.

As shown in FIG. 6B, the multi-domain layout generation system 106 provides image elements 634 (e.g., input elements that have been rendered as images) to an encoder 636. The multi-domain layout generation system 106 uses the encoder 636 to generate embeddings 608 from the image elements 604. In one or more embodiments, the multi-domain layout generation system 106 generates the embeddings 638 to represent visual characteristics and bounding box characteristics of the image elements 634.

As further shown, the multi-domain layout generation system 106 provides the embeddings 638 generated by the encoder 636 to a condition processing block 640. As illustrated, the multi-domain layout generation system 106 uses the condition processing block 640 to generate diffusion conditions 646 from the embeddings 638. Indeed, in contrast to the multi-domain diffusion neural network 602 shown in FIG. 6A, the multi-domain diffusion neural network 632 of FIG. 6B generates the diffusion conditions 646 from the embeddings 638 but not from the image domain noise input 642 or the vector domain noise input 644.

As illustrated, the multi-domain layout generation system 106 provides the image domain noise input 642 and the diffusion conditions 646 to the encoder 648 of the image diffusion branch 654. The multi-domain layout generation system 106 uses the encoder 648 to generate a first set of intermediate features from the image domain noise input 642 and the diffusion conditions 646. For instance, in some cases, the multi-domain layout generation system 106 uses the encoder 648 to generate the first set of intermediate features based on a cross attention between the image domain noise input 642 and the diffusion conditions 646.

In one or more embodiments, an intermediate feature includes a value or set of values that result from partially processing an input. In particular, in some embodiments, an intermediate feature includes a value or set of values that represent patent and/or latent attributes of an input based on a partial processing of the input. For instance, in some cases, an intermediate feature includes a feature map or set of feature maps (e.g., one or more cross-attention maps).

As further shown in FIG. 6B, the multi-domain layout generation system 106 provides the first set of intermediate features generated from the encoder 648 to the decoder 650 of the image diffusion branch 654 and the transformer neural network 652 of the vector diffusion branch 656. The multi-domain layout generation system 106 uses the transformer neural network 652 of the vector diffusion branch 656 to generate a second set of intermediate features from the first set of intermediate features. As shown, the transformer neural network 652 further generates the second set of intermediate features from the vector domain noise input 644 and the diffusion conditions 646 (which are inputs to the transformer neural network 652). In some cases, the second set of intermediate features includes internal values generated by the transformer neural network 652 (e.g., values generated before the output layer of the transformer neural network 652).

The multi-domain layout generation system 106 provides the second set of intermediate features back to the decoder 650 of the image diffusion branch 654. In one or more embodiments, the multi-domain layout generation system 106 uses the second set of intermediate features to modify or refine the first set of intermediate features and provides the modified/refined first set of intermediate features to the decoder. As indicated, the multi-domain layout generation system 106 uses the decoder 650 to generate an image domain layout 658.

Additionally, as shown in FIG. 6B, the multi-domain layout generation system 106 provides the vector domain noise input 644 and the diffusion conditions 646 to the transformer neural network 652 of the vector diffusion branch 656. The multi-domain layout generation system 106 uses the transformer neural network 652 to generate a vector domain layout 660 from the vector domain noise input 644 and the diffusion conditions 646. As shown, the transformer neural network 652 further generates the vector domain layout 660 from the first set of intermediate features generated by the encoder 648 of the image diffusion branch 654. In some cases, the multi-domain layout generation system 106 uses the second set of intermediate features generated from the first set of intermediate features in generating the vector domain layout 660.

Thus, in one or more embodiments, the multi-domain layout generation system 106 uses the image diffusion branch 654 to generate the image domain layout 658 from the embeddings 638, the image domain noise input 642, and the vector domain noise input 644. Further, the multi-domain layout generation system 106 uses the vector diffusion branch 656 to generate the vector domain layout 660 from the embeddings 638, the image domain noise input 642, and the vector domain noise input 644.

By generating the second set of intermediate features via the transformer neural network 652 of the vector diffusion branch 656 from the first set of intermediate features generated by the encoder 648 of the image diffusion branch 654, the multi-domain layout generation system 106 generates a cross-domain representation of the image elements 634 that includes values generated by both branches. Indeed, the multi-domain layout generation system 106 uses the image diffusion branch 654 and the vector diffusion branch 656 to perform a feature-level exchange of information between the image domain and the vector domain.

Though FIGS. 6A-6B illustrate the multi-domain layout generation system 106 performing diffusion in each domain in a single pass, it should be understood that various embodiments employ an iterative diffusion process in which a partially denoised output from one iteration is provided as the noise input in the next iteration. Thus, in some cases, the multi-domain layout generation system 106 uses a multi-domain diffusion neural network to gradually denoise the noise inputs over multiple iterations to generate the layouts of each domain.

By generating layouts using embeddings that incorporate the visual characteristics of the input image elements, the multi-domain layout generation system 106 provides more flexibility when compared to conventional systems. In particular, the multi-domain layout generation system 106 generates layouts that incorporate these visual characteristics, leading to layouts that improved diversity and saliency reasoning when compared to the layouts provided by conventional systems.

In one or more embodiments, the multi-domain layout generation system 106 further trains the multi-domain diffusion neural network to generate layouts from image elements. In some cases, many components of the multi-domain diffusion neural network are pre-trained. Thus, in certain implementations, the multi-domain layout generation system 106 freezes some components of the multi-domain diffusion neural network and trains others. For instance, in some implementations, the multi-domain layout generation system 106 freezes all layers of the encoder and decoder of the image diffusion branch except for the attention modules during the training process. In some embodiments, the multi-domain layout generation system 106 uses various losses in training the multi-domain diffusion neural network. For example, in some cases, the multi-domain layout generation system 106 uses an L1 loss and/or an L2 loss to incorporate image domain diffusion loss and vector domain diffusion loss. In some instances, the multi-domain layout generation system 106 also uses a domain consistency loss. Various other losses are used in various implementations.

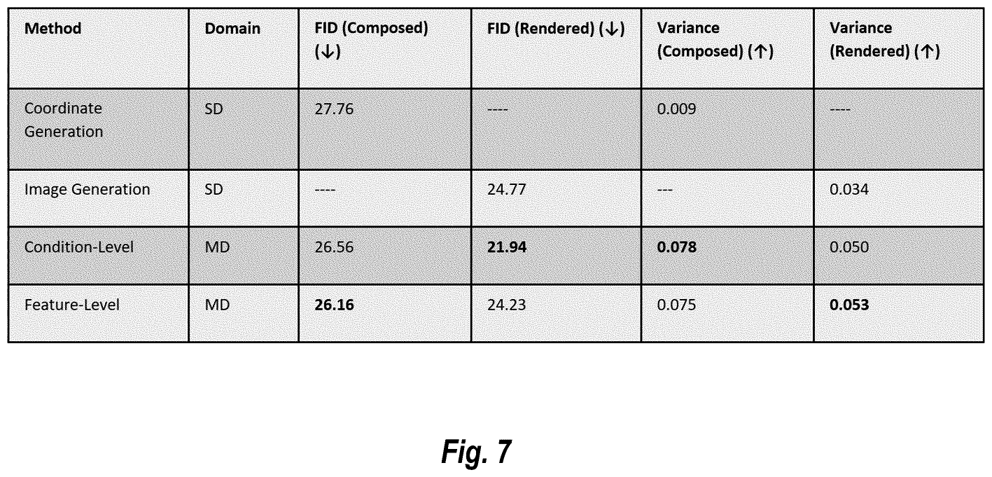

Researchers have conducted studies to determine the effectiveness of the multi-domain layout generation system 106 in generating layouts for digital designs from image elements. FIG. 7 illustrates a table reflecting experimental results regarding the effectiveness of the multi-domain layout generation system 106 in accordance with one or more embodiments.

The table of FIG. 7 compares the performance of multiple implementations of the multi-domain (MD) layout generation system 106 (labeled Condition-Level and Feature-Level) to various single domain (SD) baseline models. These baselines (labeled Coordinate Generation and Image Generation) either generate coordinates for layout elements or generate images independently without considering the layout structure.

The table compares the performance of each tested model using the average variance metric, which indicates diversity, and the Fréchet Inception Distance (FID) metric, which indicates the quality of generated images, both when rendered directly from the image domain and when composed from the input elements using predicted bounding boxes in the vector domain. Each tested model generated four layout outputs for each sample of a test set that included one thousand samples. The results shown by the table of FIG. 7 indicate that the multi-domain layout generation system 106 provides improved performance when compared to the baseline models in terms of both diversity and layout quality.

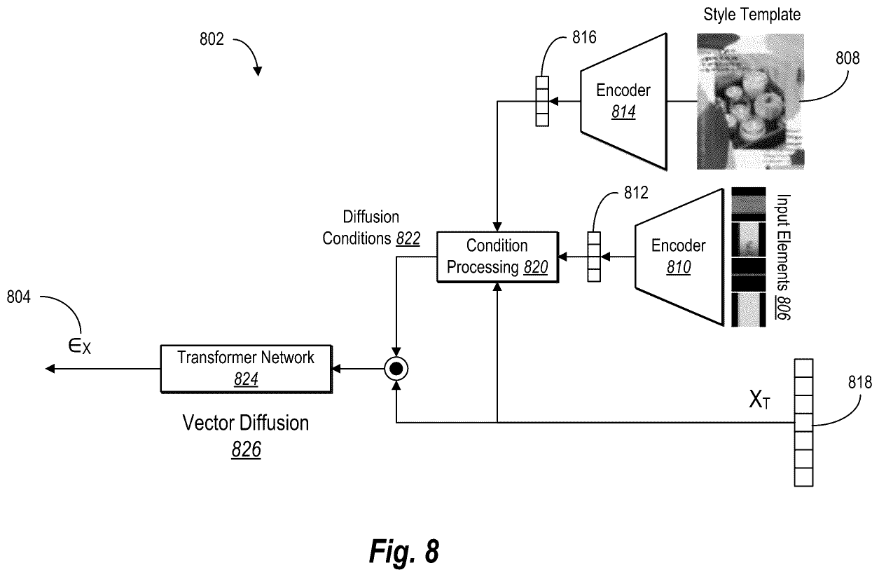

As previously discussed, in some cases, the multi-domain layout generation system 106 uses a multi-domain diffusion neural network to generate a layout from image elements via style transfer. FIG. 8 illustrates the multi-domain layout generation system 106 using a multi-domain diffusion neural network to generate a layout via style transfer in accordance with one or more embodiments.

Indeed, FIG. 8 illustrates the multi-domain layout generation system 106 using a multi-domain diffusion neural network 802 to generate a layout 804 from image elements 806 and a style template 808. In particular, the multi-domain layout generation system 106 uses the multi-domain diffusion neural network 802 to generate the layout 804 to incorporate the style portrayed by the style template 808. As shown, the architecture of the multi-domain diffusion neural network 802 is similar to the architecture portrayed in FIGS. 6A-6B with some adjustments. In other words, in some implementations, the multi-domain layout generation system 106 adapts the architecture of the implemented multi-domain diffusion neural network to enable the style transfer process.

As shown in FIG. 8, the multi-domain layout generation system 106 uses an encoder 810 to generate embeddings 812 from the image elements 806. Further, the multi-domain layout generation system 106 uses an additional encoder 814 to generate a style embedding 816 from the style template 808. In one or more embodiments, a style embedding includes an embedding having one or more values representing patent and/or latent characteristics of a style template. In particular, in some embodiments, a style embedding includes an embedding having one or more values representing characteristics of the style portrayed by the style template. In one or more embodiments, the additional encoder 814 includes the encoder of the image diffusion branch discussed above with reference to FIGS. 6A-6B.

As illustrated, the multi-domain layout generation system 106 provides the embeddings 812, the style embedding 816, and the vector domain noise input 818 to the condition processing block 820 and generates diffusion conditions 822 accordingly. Further, the multi-domain layout generation system 106 provides the diffusion conditions 822 and the vector domain noise input 818 to the transformer neural network 824 of the vector diffusion branch 826. Using the transformer neural network 824, the multi-domain layout generation system 106 generates the layout 804. Thus, in some cases, the multi-domain layout generation system 106 uses the multi-domain diffusion neural network 802 to perform diffusion in the vector domain to generate the layout 804 via style transfer. Further, the multi-domain layout generation system 106 incorporates the style template 808 into the information exchange. Indeed, in some cases, uses the additional encoder 814 to map the style template 808 to the same latent space as used in image diffusion and passes the embedded design to the input of the condition processing.

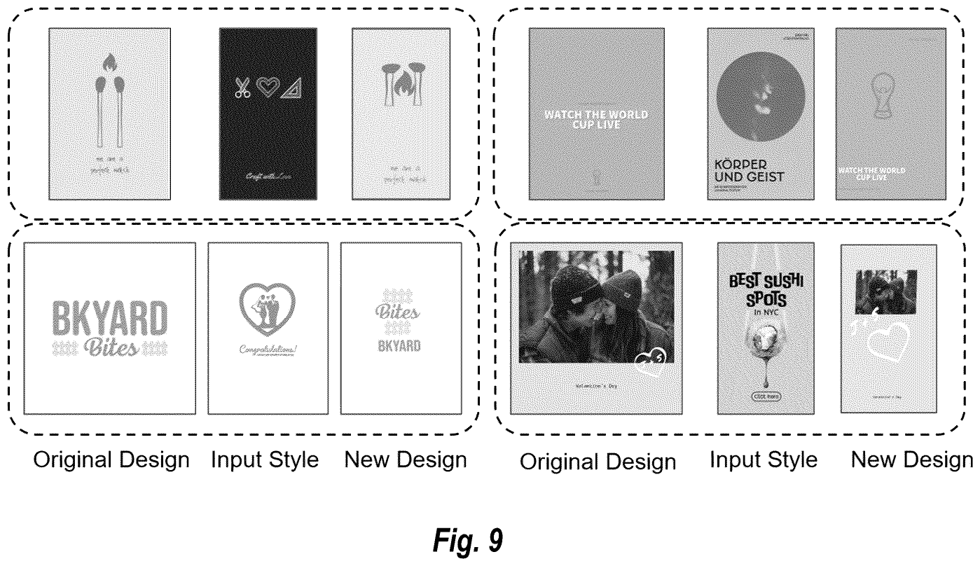

FIG. 9 illustrates qualitative results showing the effectiveness of the multi-domain layout generation system 106 in generating layouts via style transfer in accordance with one or more embodiments. The results of FIG. 9 illustrate how one or more embodiments of the multi-domain layout generation system 106 process a plurality of image elements and a style template and generate a layout that incorporates the image elements in the style of the style template.

Turning now to FIG. 10, additional detail will now be provided regarding various components and capabilities of the multi-domain layout generation system 106. In particular, FIG. 10 illustrates the multi-domain layout generation system 106 implemented by the computing device 1000 (e.g., the server(s) 102 and/or one of the client devices 110a-110n discussed above with reference to FIG. 1). Additionally, the multi-domain layout generation system 106 is part of the design editing system 104. As shown in FIG. 10, the multi-domain layout generation system 106 includes, but is not limited to, a neural network training engine 1002, a layout generator 1004, a style transfer engine 1006, a user interface manager 1008, and data storage 1010 (which includes a multi-domain diffusion neural network 1012 and style templates 1014).

As just mentioned, and as illustrated in FIG. 10, the multi-domain layout generation system 106 includes the neural network training engine 1002. In one or more embodiments, the neural network training engine 1002 trains a multi-domain diffusion neural network for generating layouts for digital designs from image elements. In particular, in some embodiments, the neural network training engine 1002 trains the multi-domain diffusion neural network to perform diffusion to generate a layout from image elements in the image domain and/or the vector domain.

Additionally, as shown in FIG. 10, the multi-domain layout generation system 106 includes the layout generator 1004. In one or more embodiments, the layout generator 1004 employs a trained multi-domain diffusion neural network to generate layouts for digital designs from image elements. Indeed, in some cases, the layout generator 1004 receives a plurality of image elements. The layout generator 1004 further generates embeddings that represent the visual and bounding box characteristics of the image elements. Additionally, the layout generator 1004 generates one or more layouts from the embeddings, an image domain noise input, and/or a vector domain noise input.

Further, as shown in FIG. 10, the multi-domain layout generation system 106 includes the style transfer engine 1006. In one or more embodiments, the style transfer engine 1006 uses a trained multi-domain diffusion neural network to generate a layout for a digital design from image elements via style transfer. In particular, in some cases, the style transfer engine 1006 adapts the architecture of a trained multi-domain diffusion neural network to use its vector diffusion branch for generating a layout that incorporates the style of a style template.

As shown in FIG. 10, the multi-domain layout generation system 106 also includes the user interface manager 1008. In one or more embodiments, the user interface manager 1008 detects and interprets user interactions with a graphical user interface. For instance, in some cases, the multi-domain layout generation system 106 detects a user selection of a selectable option for creating layouts from image elements and triggers use of a multi-domain diffusion neural network to generate the layouts in response. In some cases, the user interface manager 1008 further responds to user interactions for modifying a layout. For instance, in some implementations, the user interface manager 1008 modifies a layout by moving an image element portrayed therein (e.g., moving the bounding box of the image element) in response to one or more user interactions.

As shown in FIG. 10, the multi-domain layout generation system 106 further includes data storage 1010. In particular, data storage 1010 includes multi-domain diffusion neural network 1012 and templates 1014. In one or more embodiments, multi-domain diffusion neural network 1012 stores a multi-domain diffusion neural network trained and deployed to generate layouts for digital designs from image elements. In some embodiments, templates 1014 stores the style templates made available for generating layouts via style transfer.

Each of the components 1002-1014 of the multi-domain layout generation system 106 can include software, hardware, or both. For example, the components 1002-1014 can include one or more instructions stored on a computer-readable storage medium and executable by processors of one or more computing devices, such as a client device or server device. When executed by the one or more processors, the computer-executable instructions of the multi-domain layout generation system 106 can cause the computing device(s) to perform the methods described herein. Alternatively, the components 1002-1014 can include hardware, such as a special-purpose processing device to perform a certain function or group of functions. Alternatively, the components 1002-1014 of the multi-domain layout generation system 106 can include a combination of computer-executable instructions and hardware.

Furthermore, the components 1002-1014 of the multi-domain layout generation system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1002-1014 of the multi-domain layout generation system 106 may be implemented as a stand-alone application, such as a desktop or mobile application. Furthermore, the components 1002-1014 of the multi-domain layout generation system 106 may be implemented as one or more web-based applications hosted on a remote server. Alternatively, or additionally, the components 1002-1014 of the multi-domain layout generation system 106 may be implemented in a suite of mobile device applications or “apps.” For example, in one or more embodiments, the multi-domain layout generation system 106 can comprise or operate in connection with digital software applications such as ADOBE® ILLUSTRATOR® or ADOBE® INDESIGN®. The foregoing are either registered trademarks or trademarks of Adobe Inc. in the United States and/or other countries.

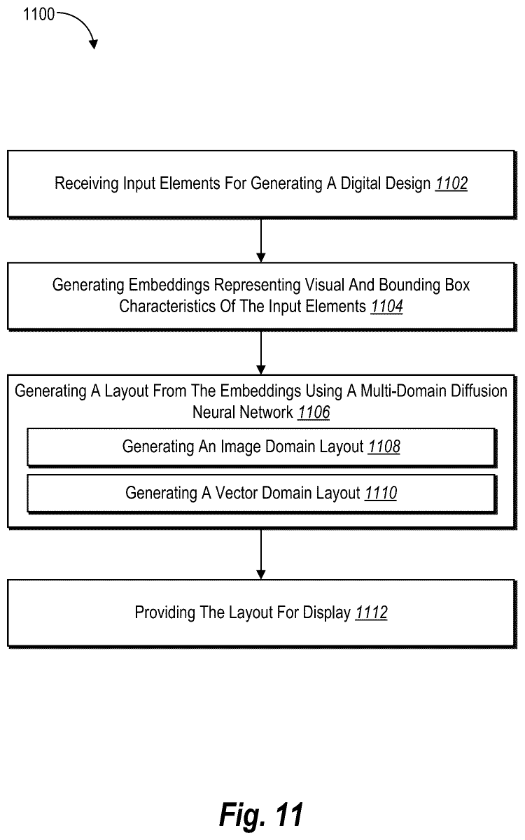

FIGS. 1-10, the corresponding text, and the examples provide a number of different methods, systems, devices, and non-transitory computer-readable media of the multi-domain layout generation system 106. In addition to the foregoing, one or more embodiments can also be described in terms of flowcharts comprising acts for accomplishing the particular result, as shown in FIG. 11. FIG. 11 may be performed with more or fewer acts. Further, the acts may be performed in different orders. Additionally, the acts described herein may be repeated or performed in parallel with one another or in parallel with different instances of the same or similar acts.

FIG. 11 illustrates a flowchart of a series of acts 1100 for using a multi-domain diffusion neural network to generate a layout for a digital design from image elements in accordance with one or more embodiments. FIG. 11 illustrates acts according to one embodiment, but alternative embodiments may omit, add to, reorder, and/or modify any of the acts shown in FIG. 11. In some implementations, the acts of FIG. 7 are performed as part of a computer-implemented method. Alternatively, a non-transitory computer-readable medium can store executable instructions thereon that, when executed by a processing device, cause the processing device to perform operations comprising the acts of FIG. 11. In some embodiments, a system performs the acts of FIG. 11. For example, in one or more embodiments, a system includes one or more memory devices. The system further includes one or more processors configured to cause the system to perform the acts of FIG. 11.

The series of acts 1100 includes an act 1102 for receiving input elements for generating a digital design. For example, in one or more embodiments, the act 1102 involves receiving, from a client device, a plurality of input elements for generating a digital design.

The series of acts 1100 also includes an act 1104 for generating embeddings representing visual and bounding box characteristics of the input elements. For instance, in some embodiments, the act 1104 involves generating, using an encoder of a multi-domain diffusion neural network, embeddings representing visual characteristics and bounding box characteristics of the plurality of input elements.

In some implementations, the multi-domain layout generation system 106 further generates a plurality of image elements from the plurality of input elements by rendering at least one image element from at least one input element of the plurality of input elements using a corresponding rendering engine, the at least one input element comprising a text element or a vector element. As such in some cases, generating, using the encoder, the embeddings representing the visual characteristics and bounding box characteristics of the plurality of input elements comprises generating the embeddings from the image elements using the encoder.

Further, the series of acts 1100 includes an act 1106 for generating a layout from the embeddings using a multi-domain diffusion neural network. To illustrate, in some cases, the act 1106 involves generating, using the multi-domain diffusion neural network, a layout for the digital design from the visual characteristics and bounding box characteristics of the embeddings.

In one or more embodiments, the multi-domain layout generation system 106 further determines an image domain noise input and a vector domain noise input for generating the digital design. As such, in some cases, generating, using the multi-domain diffusion neural network, the layout for the digital design from the visual characteristics and bounding box characteristics of the embeddings comprises generating, using the multi-domain diffusion neural network, the layout for the digital design from the embeddings, the image domain noise input, and the vector domain noise input. Additionally, in some instances, generating, using the multi-domain diffusion neural network, the layout for the digital design from the embeddings, the image domain noise input, and the vector domain noise input comprises: determining one or more diffusion conditions using the embeddings, the image domain noise input, and the vector domain noise input; and generating the layout for the digital design from the one or more diffusion conditions. Further, in some embodiments, determining the one or more diffusion conditions using the embeddings, the image domain noise input, and the vector domain noise input comprises determining, using a transformer neural network of the multi-domain diffusion neural network, the one or more diffusion conditions from the embeddings, the image domain noise input, and the vector domain noise input.

In some embodiments, generating, using the multi-domain diffusion neural network, the layout for the digital design from the embeddings, the image domain noise input, and the vector domain noise input comprises: generating, using a vector diffusion branch of the multi-domain diffusion neural network, intermediate features from the embeddings and the vector domain noise input; and generating, using an image diffusion branch of the multi-domain diffusion neural network, the layout for the digital design from the embeddings, the image domain noise input, and the intermediate features.

As shown in FIG. 7, the act 1106 includes a sub-act 1108 for generating an image domain layout. For instance, in some embodiments, generating the layout for the digital design using the multi-domain diffusion neural network comprises generating an image domain layout for the digital design using the multi-domain diffusion neural network, the image domain layout comprising a digital image portraying one or more image elements. Further, the act 1106 includes a sub-act 1110 for generating a vector domain layout. For example, in some cases, generating the layout for the digital design using the multi-domain diffusion neural network comprises generating a vector domain layout for the digital design using the multi-domain diffusion neural network, the vector domain layout comprising a plurality of bounding boxes for the plurality of input elements arranged on a canvas. Indeed, in some implementations, the multi-domain layout generation system 106 uses the multi-domain diffusion neural network to generate an image domain layout, a vector domain layout, or both.

In certain embodiments, the multi-domain layout generation system 106 further detects, via a graphical user interface of the client device, a user interaction with a bounding box from the plurality of bounding boxes; and modifies the vector domain layout by moving the bounding box within the vector domain layout in accordance with the user interaction.

In some cases, the multi-domain layout generation system 106 generates the layout via style transfer. For instance, in some embodiments, the multi-domain layout generation system 106 further receives, from the client device, a style template for generating the digital design; and generates, using an additional encoder of the multi-domain diffusion neural network, a style embedding from the style template. Accordingly, in some embodiments, generating, using the multi-domain diffusion neural network, the layout for the digital design from the visual characteristics and bounding box characteristics of the embeddings comprises generating, using the multi-domain diffusion neural network, the layout for the digital design from the embeddings and the style embedding.

Additionally, the series of acts 1100 includes an act 1112 for providing the layout for display. For example, in certain implementations, the act 1112 involves providing the layout for display on the client device.

To provide an illustration, in one or more embodiments, the multi-domain layout generation system 106 receives a plurality of image elements for generating a digital design; and generates layouts for the digital design from the plurality of image elements by using a multi-domain diffusion neural network to: generate embeddings representing visual characteristics and bounding box characteristics of the plurality of image elements; determine diffusion conditions for generating the digital design from the embeddings; generate, via an image diffusion branch, an image domain layout for the digital design from the diffusion conditions; and generate, via a vector diffusion branch, a vector domain layout for the digital design from the diffusion conditions.

In one or more embodiments, the multi-domain layout generation system 106 generates the image domain layout via the image diffusion branch by generating the image domain layout using a convolution-based diffusion neural network; and generates the vector domain layout via the vector diffusion branch by generating the vector domain layout using a transformer-based diffusion neural network. In some embodiments, the multi-domain layout generation system 106 determines an image domain noise input for the image diffusion branch and a vector domain noise input for the vector diffusion branch; and determines the diffusion conditions from the embeddings by determining the diffusion conditions from the embeddings, the image domain noise input, and the vector domain noise input. Additionally, in some cases, the multi-domain layout generation system 106 determines an image domain noise input for the image diffusion branch and a vector domain noise input for the vector diffusion branch; and generates, via the image diffusion branch, the image domain layout from the diffusion conditions by generating, via the image diffusion branch, the image domain layout from the diffusion conditions, the image domain noise input, and the vector domain noise input.

In certain cases, generating, via the image diffusion branch, the image domain layout from the diffusion conditions, the image domain noise input, and the vector domain noise input comprises: generating, using the vector diffusion branch, intermediate features from the diffusion conditions and the vector domain noise input; and generating, using the image diffusion branch, the image domain layout from the intermediate features. Further, in some embodiments, the multi-domain layout generation system 106 generates, using an encoder of the image diffusion branch, a first set of intermediate features from the diffusion conditions and the image domain noise input. As such, in some instances, generating, using the vector diffusion branch, the intermediate features from the diffusion conditions and the vector domain noise input comprises generating, using the vector diffusion branch, a second set of intermediate features from the diffusion conditions, the vector domain noise input, and the first set of intermediate features; and generating, using the image diffusion branch, the image domain layout from the intermediate features comprises generating, using a decoder of the image diffusion branch, the image domain layout from the second set of intermediate features.

In some embodiments, the multi-domain layout generation system 106 determines a vector domain noise input for the vector diffusion branch and an image domain noise input for the image diffusion branch; and generates, via the vector diffusion branch, the vector domain layout from the diffusion conditions by generating, via the vector diffusion branch, the vector domain layout from the diffusion conditions, the vector domain noise input, and the image domain noise input.

To provide another illustration, in one or more embodiments, the multi-domain layout generation system 106 generates, using an encoder of a multi-domain diffusion neural network, embeddings representing visual characteristics and bounding box characteristics of a plurality of image elements for generating a digital design; determines an image domain noise input for an image diffusion branch of the multi-domain diffusion neural network and a vector domain noise input for a vector diffusion branch of the multi-domain diffusion neural network; generates, from the embeddings, one or more cross-domain representations of the plurality of image elements by exchanging the image domain noise input and the vector domain noise input between the image diffusion branch and the vector diffusion branch; and generates, using the image diffusion branch or the vector diffusion branch of the multi-domain diffusion neural network, a layout for the digital design from the one or more cross-domain representations of the plurality of image elements.

In one or more embodiments, generating the one or more cross-domain representations of the plurality of image elements comprises generating one or more diffusion conditions for the image diffusion branch and the vector diffusion branch, the one or more diffusion conditions incorporating the image domain noise input and the vector domain noise input. In some embodiments, generating, using the image diffusion branch or the vector diffusion branch of the multi-domain diffusion neural network, the layout for the digital design from the one or more cross-domain representations comprises: generating, using the image diffusion branch, a first set of layouts for the digital design from the one or more cross-domain representations; and generating, using the vector diffusion branch, a second set of layouts for the digital design from the one or more cross-domain representations.

In some cases, the multi-domain layout generation system 106 further provides the layout for display within a graphical user interface of a client device; and modifies the layout, in response to detecting one or more interactions via the graphical user interface, by modifying at least one image element included in the layout.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of an example computing device 1200 that may be configured to perform one or more of the processes described above. One will appreciate that one or more computing devices, such as the computing device 1200 may represent the computing devices described above (e.g., the server(s) 102 and/or the client devices 110a-110n). In one or more embodiments, the computing device 1200 may be a mobile device (e.g., a mobile telephone, a smartphone, a PDA, a tablet, a laptop, a camera, a tracker, a watch, a wearable device). In some embodiments, the computing device 1200 may be a non-mobile device (e.g., a desktop computer or another type of client device). Further, the computing device 1200 may be a server device that includes cloud-based processing and storage capabilities.

As shown in FIG. 12, the computing device 1200 can include one or more processor(s) 1202, memory 1204, a storage device 1206, input/output interfaces 1208 (or “I/O interfaces 1208”), and a communication interface 1210, which may be communicatively coupled by way of a communication infrastructure (e.g., bus 1212). While the computing device 1200 is shown in FIG. 12, the components illustrated in FIG. 12 are not intended to be limiting. Additional or alternative components may be used in other embodiments. Furthermore, in certain embodiments, the computing device 1200 includes fewer components than those shown in FIG. 12. Components of the computing device 1200 shown in FIG. 12 will now be described in additional detail.

In particular embodiments, the processor(s) 1202 includes hardware for executing instructions, such as those making up a computer program. As an example, and not by way of limitation, to execute instructions, the processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 including storage for storing data or instructions. As an example, and not by way of limitation, the storage device 1206 can include a non-transitory storage medium described above. The storage device 1206 may include a hard disk drive (HDD), flash memory, a Universal Serial Bus (USB) drive or a combination these or other storage devices.

As shown, the computing device 1200 includes one or more I/O interfaces 1208, which are provided to allow a user to provide input to (such as user strokes), receive output from, and otherwise transfer data to and from the computing device 1200. These I/O interfaces 1208 may include a mouse, keypad or a keyboard, a touch screen, camera, optical scanner, network interface, modem, other known I/O devices or a combination of such I/O interfaces 1208. The touch screen may be activated with a stylus or a finger.

The I/O interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1208 are configured to provide graphical data to a display for presentation to a user. The graphical data may be representative of one or more graphical user interfaces and/or any other graphical content as may serve a particular implementation.

The computing device 1200 can further include a communication interface 1210. The communication interface 1210 can include hardware, software, or both. The communication interface 1210 provides one or more interfaces for communication (such as, for example, packet-based communication) between the computing device and one or more other computing devices or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can include hardware, software, or both that connects components of computing device 1200 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, from a client device, a plurality of input elements for generating a digital design;
generating, using an encoder of a multi-domain diffusion neural network, embeddings representing visual characteristics and bounding box characteristics of the plurality of input elements;
generating, using the multi-domain diffusion neural network, a layout for the digital design from the visual characteristics and bounding box characteristics of the embeddings; and
providing the layout for display on the client device.

2. The computer-implemented method of claim 1,
further comprising generating a plurality of image elements from the plurality of input elements by rendering at least one image element from at least one input element of the plurality of input elements using a corresponding rendering engine, the at least one input element comprising a text element or a vector element,
wherein generating, using the encoder, the embeddings representing the visual characteristics and bounding box characteristics of the plurality of input elements comprises generating the embeddings from the plurality of image elements using the encoder.

3. The computer-implemented method of claim 1,
further comprising determining an image domain noise input and a vector domain noise input for generating the digital design,
wherein generating, using the multi-domain diffusion neural network, the layout for the digital design from the visual characteristics and bounding box characteristics of the embeddings comprises generating, using the multi-domain diffusion neural network, the layout for the digital design from the embeddings, the image domain noise input, and the vector domain noise input.

4. The computer-implemented method of claim 3, wherein generating, using the multi-domain diffusion neural network, the layout for the digital design from the embeddings, the image domain noise input, and the vector domain noise input comprises:
determining one or more diffusion conditions using the embeddings, the image domain noise input, and the vector domain noise input; and
generating the layout for the digital design from the one or more diffusion conditions.

5. The computer-implemented method of claim 4, wherein determining the one or more diffusion conditions using the embeddings, the image domain noise input, and the vector domain noise input comprises determining, using a transformer neural network of the multi-domain diffusion neural network, the one or more diffusion conditions from the embeddings, the image domain noise input, and the vector domain noise input.

6. The computer-implemented method of claim 3, wherein generating, using the multi-domain diffusion neural network, the layout for the digital design from the embeddings, the image domain noise input, and the vector domain noise input comprises:
generating, using a vector diffusion branch of the multi-domain diffusion neural network, intermediate features from the embeddings and the vector domain noise input; and
generating, using an image diffusion branch of the multi-domain diffusion neural network, the layout for the digital design from the embeddings, the image domain noise input, and the intermediate features.

7. The computer-implemented method of claim 1, wherein generating the layout for the digital design using the multi-domain diffusion neural network comprises generating an image domain layout for the digital design using the multi-domain diffusion neural network, the image domain layout comprising a digital image portraying one or more image elements.

8. The computer-implemented method of claim 1, wherein generating the layout for the digital design using the multi-domain diffusion neural network comprises generating a vector domain layout for the digital design using the multi-domain diffusion neural network, the vector domain layout comprising a plurality of bounding boxes for the plurality of input elements arranged on a canvas.

9. The computer-implemented method of claim 8, further comprising:
detecting, via a graphical user interface of the client device, a user interaction with a bounding box from the plurality of bounding boxes; and
modifying the vector domain layout by moving the bounding box within the vector domain layout in accordance with the user interaction.

10. The computer-implemented method of claim 1, further comprising:
receiving, from the client device, a style template for generating the digital design; and
generating, using an additional encoder of the multi-domain diffusion neural network, a style embedding from the style template,
wherein generating, using the multi-domain diffusion neural network, the layout for the digital design from the visual characteristics and bounding box characteristics of the embeddings comprises generating, using the multi-domain diffusion neural network, the layout for the digital design from the embeddings and the style embedding.

11. A system comprising:
one or more memory devices; and
one or more processors configured to cause the system to:
receive a plurality of image elements for generating a digital design; and
generate layouts for the digital design from the plurality of image elements by using a multi-domain diffusion neural network to:
generate embeddings representing visual characteristics and bounding box characteristics of the plurality of image elements;
determine diffusion conditions for generating the digital design from the embeddings;
generate, via an image diffusion branch, an image domain layout for the digital design from the diffusion conditions; and
generate, via a vector diffusion branch, a vector domain layout for the digital design from the diffusion conditions.

12. The system of claim 11, wherein the one or more processors are configured to cause the system to:
generate the image domain layout via the image diffusion branch by generating the image domain layout using a convolution-based diffusion neural network; and
generate the vector domain layout via the vector diffusion branch by generating the vector domain layout using a transformer-based diffusion neural network.

13. The system of claim 11, wherein the one or more processors are further configured to cause the system to:
determining an image domain noise input for the image diffusion branch and a vector domain noise input for the vector diffusion branch; and
determine the diffusion conditions from the embeddings by determining the diffusion conditions from the embeddings, the image domain noise input, and the vector domain noise input.

14. The system of claim 11, wherein the one or more processors are further configured to cause the system to:
determine an image domain noise input for the image diffusion branch and a vector domain noise input for the vector diffusion branch; and
generate, via the image diffusion branch, the image domain layout from the diffusion conditions by generating, via the image diffusion branch, the image domain layout from the diffusion conditions, the image domain noise input, and the vector domain noise input.

15. The system of claim 14, wherein generating, via the image diffusion branch, the image domain layout from the diffusion conditions, the image domain noise input, and the vector domain noise input comprises:
generating, using the vector diffusion branch, intermediate features from the diffusion conditions and the vector domain noise input; and
generating, using the image diffusion branch, the image domain layout from the intermediate features.

16. The system of claim 15, wherein:
the one or more processors are further configured to cause the system to generate, using an encoder of the image diffusion branch, a first set of intermediate features from the diffusion conditions and the image domain noise input;
generating, using the vector diffusion branch, the intermediate features from the diffusion conditions and the vector domain noise input comprises generating, using the vector diffusion branch, a second set of intermediate features from the diffusion conditions, the vector domain noise input, and the first set of intermediate features; and
generating, using the image diffusion branch, the image domain layout from the intermediate features comprises generating, using a decoder of the image diffusion branch, the image domain layout from the second set of intermediate features.

17. The system of claim 11, wherein the one or more processors are further configured to cause the system to:
determine a vector domain noise input for the vector diffusion branch and an image domain noise input for the image diffusion branch; and
generate, via the vector diffusion branch, the vector domain layout from the diffusion conditions by generating, via the vector diffusion branch, the vector domain layout from the diffusion conditions, the vector domain noise input, and the image domain noise input.

18. A non-transitory computer-readable medium storing executable instructions which, when executed by a processing device, cause the processing device to perform operations comprising:
generating, using an encoder of a multi-domain diffusion neural network, embeddings representing visual characteristics and bounding box characteristics of a plurality of image elements for generating a digital design;
determining an image domain noise input for an image diffusion branch of the multi-domain diffusion neural network and a vector domain noise input for a vector diffusion branch of the multi-domain diffusion neural network;
generating, from the embeddings, one or more cross-domain representations of the plurality of image elements by exchanging the image domain noise input and the vector domain noise input between the image diffusion branch and the vector diffusion branch; and
generating, using the image diffusion branch or the vector diffusion branch of the multi-domain diffusion neural network, a layout for the digital design from the one or more cross-domain representations of the plurality of image elements.

19. The non-transitory computer-readable medium of claim 18, wherein generating the one or more cross-domain representations of the plurality of image elements comprises generating one or more diffusion conditions for the image diffusion branch and the vector diffusion branch, the one or more diffusion conditions incorporating the image domain noise input and the vector domain noise input.

20. The non-transitory computer-readable medium of claim 18, wherein generating, using the image diffusion branch or the vector diffusion branch of the multi-domain diffusion neural network, the layout for the digital design from the one or more cross-domain representations comprises:
generating, using the image diffusion branch, a first set of layouts for the digital design from the one or more cross-domain representations; and
generating, using the vector diffusion branch, a second set of layouts for the digital design from the one or more cross-domain representations.
